(19) United States
(12) Patent Application Publication
(10) Pub. No.: US 2020/0285432 A1
(43) Pub. Date: Sep. 10, 2020

(54) IMAGE FORMING APPARATUS AND INFORMATION PROCESSING APPARATUS

(71) Applicant: FUJI XEROX CO., LTD., Tokyo (JP)

(72) Inventor: Koichiro MINO, Kanagawa (JP)

(73) Assignee: FUJI XEROX CO., LTD., Tokyo (JP)

(21) Appl. No.: 16/544,893

(22) Filed: Aug. 19, 2019

(30) Foreign Application Priority Data
Mar. 4, 2019 (JP) 2019-038964

(51) Int. Cl. G06F 3/12

(52) U.S. Cl. CPC G06F 3/1222; G06F 3/1238; G06F 3/1247; G06F 3/1287; G06F 3/1292

(57) ABSTRACT

An image forming apparatus includes an acquirer that accesses a storage area on an Internet, which is specified by a user and has no limit for access authority, and acquires first data formats providable by an information processing apparatus as print data, a writer that writes, in the storage area, a second data format processable by the image forming apparatus among the acquired first data formats, and a downloader that downloads print data in the second data format when the print data in the second data format is stored in the storage area.

### CROSS-REFERENCE TO RELATED APPLICATIONS

This application is based on and claims priority under 35 USC 119 from Japanese Patent Application No. 2019-038964 filed Mar. 4, 2019.

### BACKGROUND

### (i) Technical Field

The present disclosure relates to an image forming apparatus and an information processing apparatus.

### (ii) Related Art

To print contents in an image forming apparatus (printer), it is necessary to provide print data that meets specifications of the image forming apparatus. A program called printer driver is required to generate print data that meets specifications. The printer driver is provided for each image forming apparatus. A printer driver of an image forming apparatus for daily use is installed in an information processing apparatus by a user.

Contents are not always printed in daily situations. For example, a person may desire to print contents on a trip or at an outside place. In many cases, a printer driver of an image forming apparatus available at a place on a trip or the like is not installed in the information processing apparatus of the user.

Japanese Unexamined Patent Application Publication No. 2018-106362 is an example of related art.

### SUMMARY

Aspects of non-limiting embodiments of the present disclosure relate to the following circumstances. In many cases, the information processing apparatus to be operated by the user is not connectable to the same network as that for an image forming apparatus installed in a public place. A format conversion service to be provided by a dedicated server may be used but user registration is required for the conversion service and the user's registration work is bothersome. The user also needs to give an instruction on a service screen to the image forming apparatus to be used for printing contents.

It is also desirable to reduce a burden on a person who installed the image forming apparatus compared with a case in which there is a need to install a server that converts the format of contents into a data format printable by the image forming apparatus.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming apparatus comprising an acquirer that accesses a storage area on an Internet, which is specified by a user and has no limit for access authority, and acquires first data formats providable by an information processing apparatus as print data, a writer that writes, in the storage area, a second data format processable by the image forming apparatus among the acquired first data formats, and a downloader that downloads print data in the second data format when the print data in the second data format is stored in the storage area.

### BRIEF DESCRIPTION OF THE DRAWINGS

Exemplary embodiments of the present disclosure will be described in detail based on the following figures, wherein:

FIG. 1 illustrates a conceptual configuration of an information processing system for use in a first exemplary embodiment;

FIG. 2 illustrates an example of the configuration of an image forming apparatus for use in the first exemplary embodiment;

FIG. 3 illustrates the functional configuration of a control unit of the image forming apparatus for use in the first exemplary embodiment;

FIG. 4 illustrates an example of format-request.txt;

FIG. 5 illustrates an example of format-response.txt;

FIG. 6 is a flowchart for describing a processing operation to be executed by the image forming apparatus for use in the first exemplary embodiment;

FIG. 7 illustrates an example of the configuration of a terminal apparatus for use in the first exemplary embodiment;

FIG. 8 illustrates the functional configuration of a control unit of the terminal apparatus for use in the first exemplary embodiment;

FIG. 9 is a flowchart for describing a processing operation to be executed by the terminal apparatus for use in the first exemplary embodiment;

FIG. 10 illustrates an example of a processing sequence to be executed in the information processing system of the first exemplary embodiment;

FIG. 11 illustrates a conceptual configuration of an information processing system for use in a second exemplary embodiment;

FIG. 12 illustrates the functional configuration of a control unit of an image forming apparatus for use in the second exemplary embodiment;

FIG. 13 is a flowchart for describing a processing operation to be executed by the image forming apparatus for use in the second exemplary embodiment;

FIG. 14 illustrates the functional configuration of a control unit of a terminal apparatus for use in the second exemplary embodiment;

FIG. 15 is a flowchart for describing a processing operation to be executed by the terminal apparatus for use in the second exemplary embodiment; and

FIG. 16 illustrates an example of a processing sequence to be executed in the information processing system of the second exemplary embodiment.

### DETAILED DESCRIPTION

Exemplary embodiments of the present disclosure are described below with reference to the drawings.

### First Exemplary Embodiment

### <Overall System Configuration>

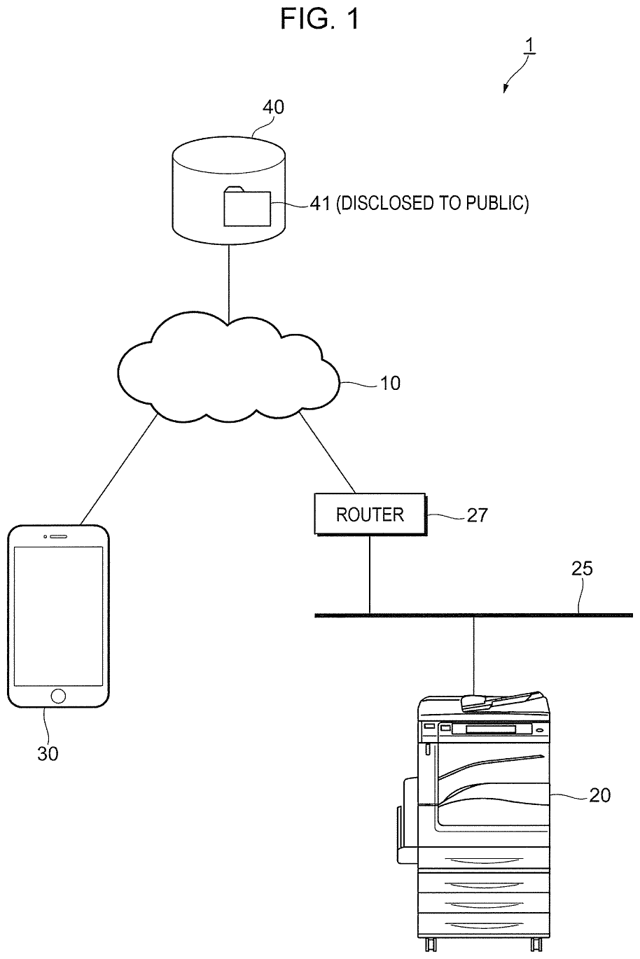

FIG. 1 illustrates a conceptual configuration of an information processing system 1 for use in a first exemplary embodiment. The information processing system 1 includes the Internet 10, an image forming apparatus 20, a local area network (LAN) 25, a router 27, a terminal apparatus 30 that may be carried by a user, and a cloud storage 40.

FIG. 1 illustrates one image forming apparatus 20, one terminal apparatus 30, and one cloud storage 40. The information processing system 1 may include a plurality of image forming apparatuses 20, a plurality of terminal apparatuses 30, and a plurality of cloud storages 40. The cloud storage 40 is provided for a cloud service.

In this exemplary embodiment, the image forming apparatus 20 is installed in a place different from an organization or house to which the user of the terminal apparatus 30 belongs. Examples of the place may include an outside place, a place on a trip, and a public place.

The image forming apparatus 20 and the router 27 are connected to the LAN 25. In other words, the image forming apparatus 20 and the router 27 belong to the same network.

The router 27 has a firewall function. The router 27 discards connection requests from the Internet 10 but requests to be output to the Internet 10 and responses to the requests are allowed to pass through the router 27. Thus, the image forming apparatus 20 may read and write data between the image forming apparatus 20 and the cloud storage 40. No access point of a wireless LAN is connected to the LAN 25. Therefore, the terminal apparatus 30 is not connectable to the image forming apparatus 20 via a wireless network.

The terminal apparatus 30 of this exemplary embodiment is a portable terminal. Examples of the portable terminal include a smartphone, a wearable terminal, and a notebook computer. The terminal apparatus 30 may read and write data between the terminal apparatus 30 and the cloud storage 40 via the Internet 10 but is not connectable to the image forming apparatus 20 via a network. The terminal apparatus 30 is an example of an information processing apparatus.

The cloud storage 40 is a storage area present on the Internet 10 and is used for storing or sharing data files. In this exemplary embodiment, the storage area to be used for storing or sharing data files for printing in an external environment is referred to as a folder 41. Examples of the cloud storage 40 may include DROPBOX (registered trademark), One Drive (registered trademark), and Google Drive (trademark).

### <Configurations of Apparatuses>

### <Configuration of Image Forming Apparatus>

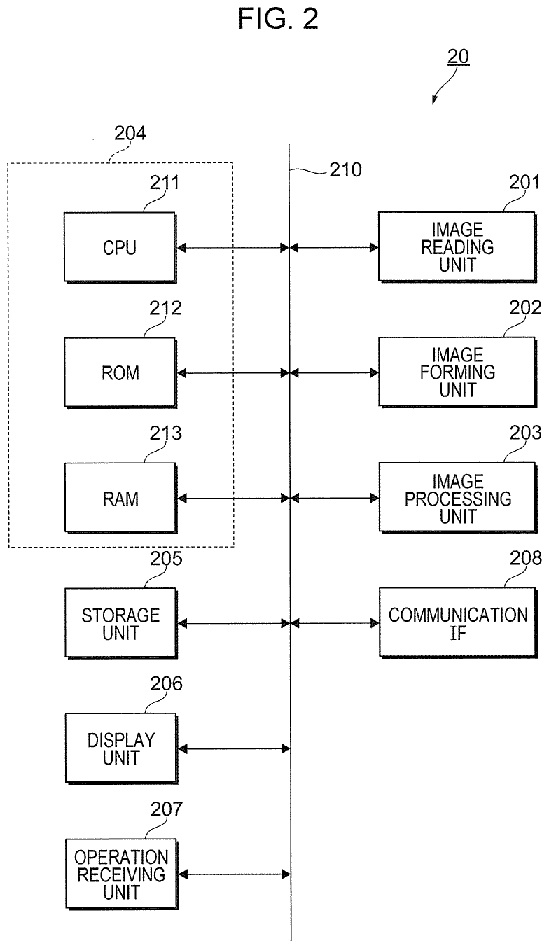

FIG. 2 illustrates an example of the configuration of the image forming apparatus 20 for use in the first exemplary embodiment.

The image forming apparatus 20 includes an image reading unit 201 that reads an image of a document, an image forming unit 202 that forms an image on paper that is an example of a recording medium, an image processing unit 203 that performs processing such as color correction and gray level correction for an image indicated by image data, a control unit 204 that controls an overall operation of the apparatus, a storage unit 205 that stores image data and the like, a display unit 206 to be used for displaying a user interface screen and the like, an operation receiving unit 207 that receives a user's operation, and a communication interface (communication IF) 208 that implements communication via the LAN 25 and the like.

The image reading unit 201 is a so-called scanner and may have a mechanism that automatically transports a document.

The image forming unit 202 forms an image on the recording medium by using an electrophotographic system, an inkjet system, or the like and has a mechanism specific to the image forming system.

The image processing unit 203 is a dedicated processor or processing circuit that processes image data.

The control unit 204 includes a central processing unit (CPU) 211, a read only memory (ROM) 212 that stores firmware, a basic input/output system (BIOS), and the like, and a random access memory (RAM) 213 to be used as a working area. The control unit 204 functions as a so-called computer.

For example, the storage unit 205 is a hard disk drive (HDD) that is a non-volatile storage apparatus. The storage unit 205 stores image data obtained by reading an image by the image reading unit 201, image data provided from the outside through communication, image data received through FAX communication, and the like.

For example, the display unit 206 is a liquid crystal display or an organic electroluminescence (EL) display. The display surface of the display unit 206 is an example of a display part.

The operation receiving unit 207 is a touch sensor, a switch, a button, or the like arranged on the surface of the display unit 206.

The control unit 204 and the respective units are connected through a bus 210 and signal lines (not illustrated).

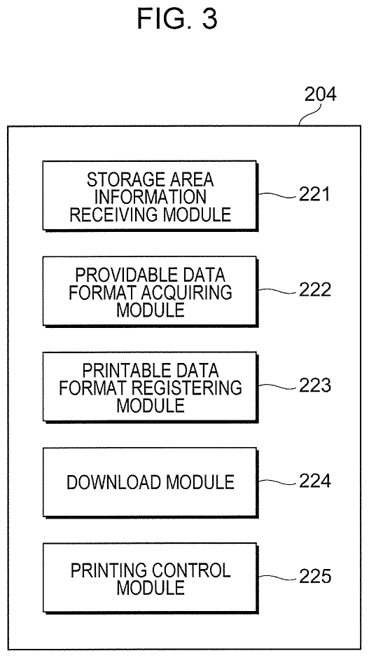

FIG. 3 illustrates the functional configuration of the control unit 204 of the image forming apparatus 20 for use in the first exemplary embodiment. Functional modules illustrated in FIG. 3 are implemented through execution of a program by the CPU 211 (see FIG. 2). The functional modules illustrated in FIG. 3 are examples of functional modules provided by the control unit 204.

The control unit 204 of this exemplary embodiment functions as a storage area information receiving module 221 that receives information related to the location of the folder 41 (see FIG. 1) specified by the user, a providable data format acquiring module 222 that acquires, from the folder 41, information on data formats providable by the terminal apparatus 30, a printable data format registering module 223 that registers, in the folder 41, data formats printable by the image forming apparatus 20, a download module 224 that downloads print data from the folder 41, and a printing control module 225 that controls printing (image formation) that uses the downloaded print data.

The storage area information receiving module 221 receives information indicating the location of the folder 41 on the Internet, which is generated or specified by the user on the cloud storage 40 (see FIG. 1). For example, the information indicating the location on the Internet is a uniform resource locator (URL).

In this exemplary embodiment, the information indicating the location of the folder 41 on the Internet is represented by a two-dimensional code. Examples of the two-dimensional code include a quick response (QR) code. The two-dimensional code may be printed in advance on a recording medium such as paper. In this exemplary embodiment, the two-dimensional code is displayed on a display screen of the terminal apparatus 30 operated by the user.

In this exemplary embodiment, the storage area information receiving module 221 receives the location of the folder 41 generated on the Internet by processing an image of the two-dimensional code read by the image reading unit 201 (see FIG. 2).

The providable data format acquiring module 222 accesses the folder 41 on the Internet that is specified by the user and acquires a file that describes data formats providable by the terminal apparatus 30 as print data. In this exemplary embodiment, the providable data format is described in a text file format. The text file is assigned a predetermined file name such as “format-request.txt”.

In this exemplary embodiment, the data formats providable by the terminal apparatus 30 as print data include a format that may be output as an image and a format that may be output as application software (hereinafter referred to as “application”).

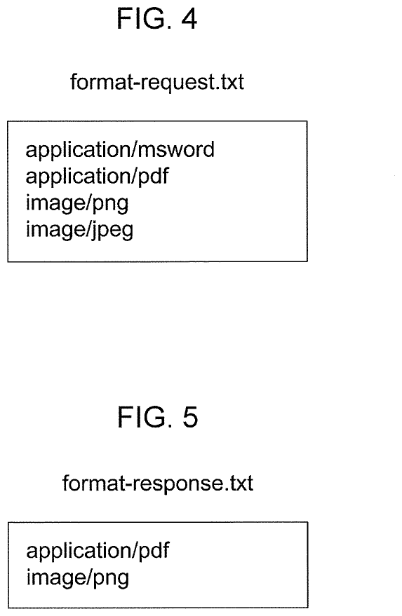

FIG. 4 illustrates an example of format-request.txt. In the case of the text file illustrated in FIG. 4, the terminal apparatus 30 may output an image in a PNG format or a JPEG format and may output a document application in a Word format or a PDF format. The four formats described in format-request.txt are examples of a first data format. The providable data format acquiring module 222 is an example of an acquirer.

Description is made again with reference to FIG. 3.

The printable data format registering module 223 registers data formats processable by the image forming apparatus 20 among the acquired data formats in the folder 41 from which the file of format-request.txt is acquired. The processable data format is also described in a text file format. The text file is assigned a predetermined file name such as “format-response.txt”. If a plurality of processable data formats are present, the plurality of data formats are described.

In this exemplary embodiment, for example, the printable data format registering module 223 keeps descriptions of the processable data formats in format-request.txt (that is, deletes non-printable data formats) and then changes the file name. Equivalently, the text file registered by the terminal apparatus 30 is deleted.

FIG. 5 illustrates an example of format-response.txt. In the case of the text file illustrated in FIG. 5, an image may be processed in the PNG format and a document application may be processed in the PDF format. The two formats described in format-response.txt are examples of a second data format. The printable data format registering module 223 is an example of a writer.

Description is made again with reference to FIG. 3.

When print data is stored in the folder 41 specified by the user, the download module 224 downloads the stored print data. The download module 224 is an example of a downloader.

The printing control module 225 controls operations of the image forming unit 202 (see FIG. 2) and the image processing unit 203 (see FIG. 2) to print an image on paper.

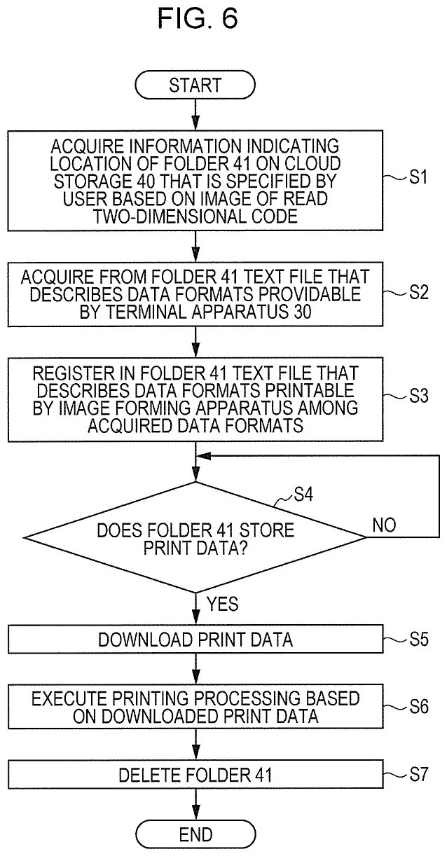

FIG. 6 is a flowchart for describing a processing operation to be executed by the image forming apparatus 20 for use in the first exemplary embodiment. The processing operation illustrated in FIG. 6 is implemented by cooperation between the modules described above. The symbol S in FIG. 6 represents a step.

The processing illustrated in FIG. 6 is started when the image reading unit 201 (see FIG. 2) reads the display screen of the terminal apparatus 30 (see FIG. 1) that displays an image of a QR code (registered trademark) indicating the location of the folder 41 (see FIG. 1) generated on the cloud storage 40 (see FIG. 1).

The image forming apparatus 20 acquires information indicating the location of the folder 41 on the cloud storage 40 that is specified by the user based on the image of the read two-dimensional code (Step 1). The folder 41 is set as a shared area. Therefore, anyone may access the folder 41 as well as the user who is operating the apparatus.

Next, the image forming apparatus 20 acquires, from the folder 41, a text file that describes data formats providable by the terminal apparatus 30 (Step 2). As described above, the text file is assigned the file name “format-request.txt”.

Then, the image forming apparatus 20 registers, in the folder 41, a text file that describes data formats printable by the image forming apparatus 20 among the acquired data formats (Step 3). As described above, the text file is assigned the file name “format-response.txt”.

Then, the image forming apparatus 20 determines whether the folder 41 stores print data (Step 4).

When the result is “NO” in Step 4, the image forming apparatus 20 periodically accesses the folder 41 and determines whether print data is stored.

When the result is “YES” in Step 4, the image forming apparatus 20 downloads the print data from the folder 41 (Step 5).

Next, the image forming apparatus 20 executes printing processing based on the downloaded print data (Step 6).

When the printing is finished, the image forming apparatus 20 deletes the folder 41 (Step 7). When the folder 41 used for data exchange is deleted, the print data and format-response.txt are also deleted together. The deletion is complete deletion by which corresponding files are not left even in a recycle bin. Thus, the confidentiality of the print data is maintained.

### <Configuration of Terminal Apparatus>

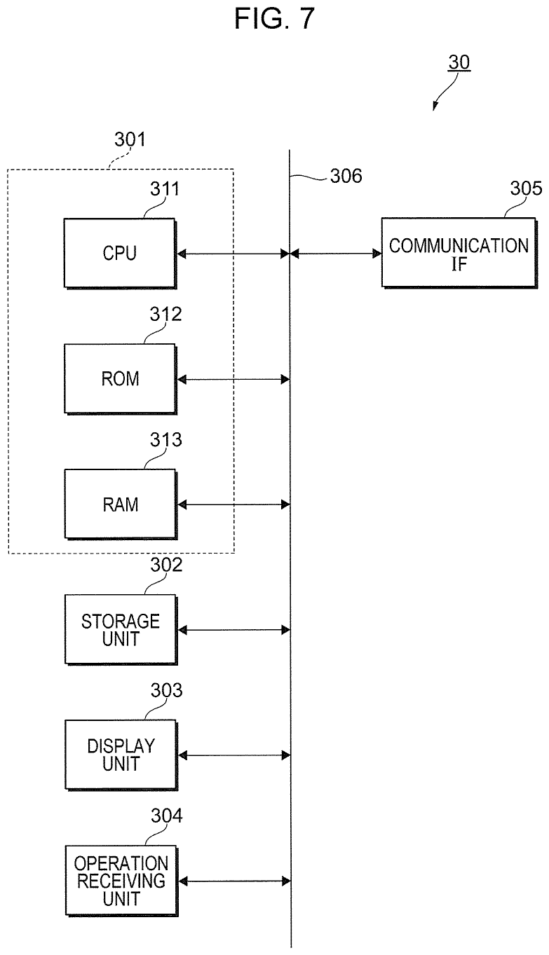

FIG. 7 illustrates an example of the configuration of the terminal apparatus 30 for use in the first exemplary embodiment.

The terminal apparatus 30 includes a control unit 301 that controls an overall operation of the apparatus, a storage unit 302 that stores image data and the like, a display unit 303 to be used for displaying a user interface screen and the like, an operation receiving unit 304 that receives a user's operation, and a communication interface (communication IF) 305 that implements communication via the Internet 10.

The control unit 301 of this exemplary embodiment includes a CPU 311, a ROM 312 that stores firmware, a BIOS, and the like, and a RAM 313 to be used as a working area. The control unit 301 functions as a so-called computer.

For example, the storage unit 302 is a non-volatile rewritable semiconductor memory. For example, the storage unit 302 stores image data and document data as printing targets.

For example, the display unit 303 is a liquid crystal display or an organic EL display. The display unit 303 displays the two-dimensional code described above.

The operation receiving unit 304 is a touch sensor, a switch, a button, or the like arranged on the surface of the display unit 303.

The control unit 301 and the respective units are connected through a bus 306 and signal lines (not illustrated).

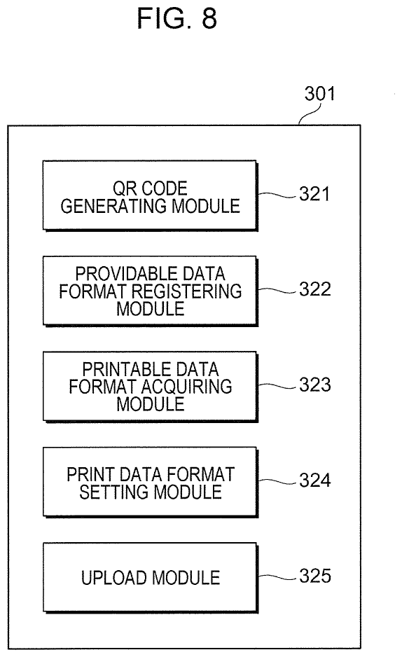

FIG. 8 illustrates the functional configuration of the control unit 301 of the terminal apparatus 30 for use in the first exemplary embodiment. Functional modules illustrated in FIG. 8 are implemented through execution of a program by the CPU 311 (see FIG. 7). The functional modules illustrated in FIG. 8 are examples of functional modules provided by the control unit 301.

The control unit 301 of this exemplary embodiment functions as a QR code generating module 321 that converts, into a two-dimensional code, a URL indicating the location of the folder 41 generated on the Internet by the user, a providable data format registering module 322 that registers, in the folder 41, data formats providable by the terminal apparatus 30, a printable data format acquiring module 323 that acquires printable data formats stored in the folder 41, a print data format setting module 324 that sets one of the acquired data formats as the format of print data, and an upload module 325 that uploads the generated print data to the folder 41.

The QR code generating module 321 converts, into a two-dimensional code, a URL indicating the location of the folder 41 generated on the cloud storage 40 through an operation for the terminal apparatus 30 and displays the two-dimensional code on the display screen of the terminal apparatus 30.

The providable data format registering module 322 detects data formats of document data and image data that are convertible from the data format of a file specified as a printing target in the terminal apparatus 30 and registers a text file that describes the detected data formats (format-request.txt) in the folder 41 identified by the URL described above. The providable data format registering module 322 is an example of the writer.

The printable data format acquiring module 323 periodically accesses the folder 41 that stores the text file that describes the providable data formats and monitors registration of format-response.txt, which is a response from the image forming apparatus 20. When the registration is detected, the printable data format acquiring module 323 acquires printable data formats from format-response.txt.

The print data format setting module 324 sets one of the acquired printable data formats as the data format of current print data.

The upload module 325 is an example of an uploader.

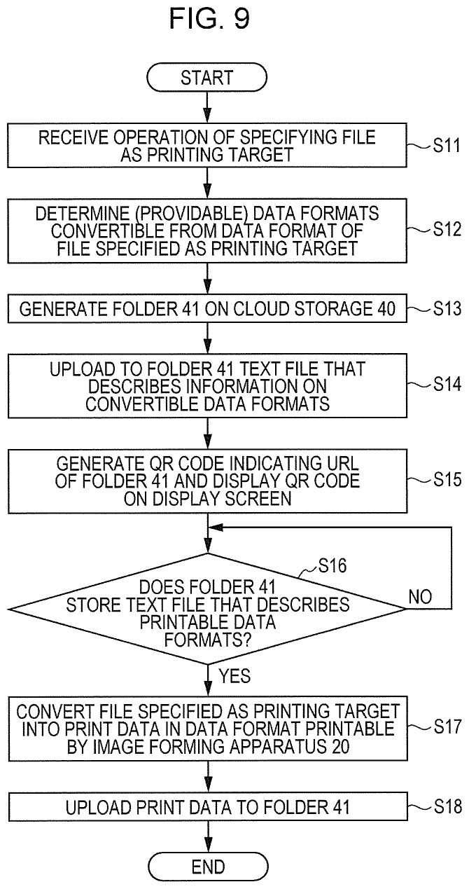

FIG. 9 is a flowchart for describing a processing operation to be executed by the terminal apparatus 30 for use in the first exemplary embodiment. The processing operation illustrated in FIG. 9 is implemented by cooperation between the modules described above. The symbol S in FIG. 9 represents a step.

First, the terminal apparatus 30 receives an operation of specifying a file as a printing target (Step 11). The operation of specifying the file is received via an operation screen of the terminal apparatus 30.

Next, the terminal apparatus 30 determines data formats convertible from the data format of the file specified as the printing target (Step 12). As described above, the convertible data format is a data format providable by the terminal apparatus 30.

Then, the terminal apparatus 30 generates the folder 41 on the cloud storage 40 in response to a user's operation (Step 13).

Then, the terminal apparatus 30 uploads, to the folder 41, a text file that describes information on the convertible data formats (Step 14). Specifically, the terminal apparatus 30 uploads format-request.txt.

Next, the terminal apparatus 30 generates a QR code indicating a URL of the folder 41 and displays the QR code on the display screen (Step 15).

Then, the terminal apparatus 30 determines whether the folder 41 stores a text file that describes printable data formats (Step 16). The folder 41 is identical to the folder 41 generated in Step 13. Specifically, the terminal apparatus 30 determines whether format-response.txt is stored.

Next, the terminal apparatus 30 converts the file specified as the printing target into print data in a data format printable by the image forming apparatus 20 (Step 17). The file specified as the printing target is the file specified in Step 11. When a plurality of data formats are described in the text file whose storage has been confirmed in Step 16, one data format is determined in accordance with a predetermined rule.

The print data is a data file having a specified data format. If the data format of the specified file is the printable data format, the terminal apparatus 30 does not convert the data again.

Then, the terminal apparatus 30 uploads the print data to the folder 41 (Step 18).

### <Example of Processing Sequence>

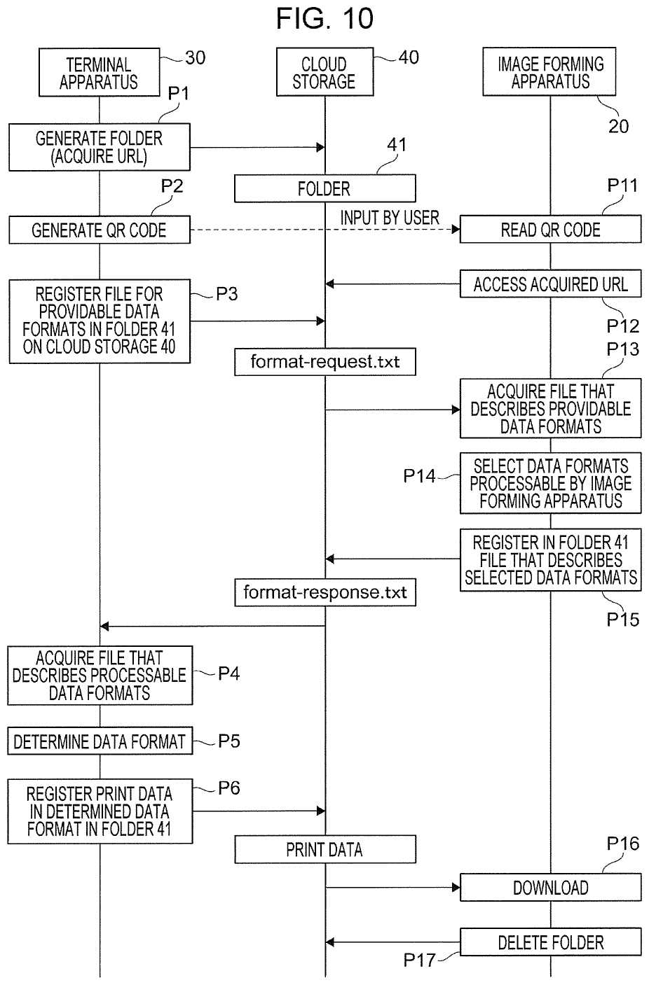

FIG. 10 illustrates an example of a processing sequence to be executed in the information processing system 1 of the first exemplary embodiment. The symbol P in FIG. 10 represents a process.

The processing sequence is started when a user who desires printing at an outside place or the like operates the terminal apparatus 30 to generate the folder 41 on the cloud storage 40 (Process 1). For example, the necessity of the operation may be presented by a printing application started by the user. The folder 41 is set so as not to limit users having accessibility (that is, disclosed to public).

The terminal apparatus 30 that has acquired a URL of the generated folder 41 generates a QR code indicating the URL (Process 2).

When the QR code is generated, the terminal apparatus 30 registers a file for data formats providable by the terminal apparatus 30 in the folder 41 on the cloud storage 40 (Process 3). As a result, format-request.txt is registered in the folder 41 on the cloud storage 40.

The processing sequence described above is executed independently in the terminal apparatus 30.

The image forming apparatus 20 reads the QR code displayed on the display screen of the terminal apparatus 30 in response to a user's operation (Process 11) to acquire the URL from the QR code.

Next, the image forming apparatus 20 accesses the acquired URL (Process 12). The access is periodically executed until format-request.txt is registered in the folder 41 indicated by the URL.

When the corresponding file is registered in the folder 41, the image forming apparatus 20 acquires the file that describes the providable data formats (Process 13). The file is format-request.txt described above.

Next, the image forming apparatus 20 selects data formats processable by the image forming apparatus 20 from among the data formats described in the acquired file (Process 14).

Then, the image forming apparatus 20 registers, in the folder 41, a file that describes the selected data formats (Process 15). The file is format-response.txt.

The processing sequence described above is executed independently in the image forming apparatus 20.

The terminal apparatus 30 that has executed Process 3 periodically accesses the folder 41 and waits for registration of the file that describes the processable data formats.

When the corresponding file is registered in the folder 41, the terminal apparatus 30 acquires the file that describes the processable data formats (Process 4).

Next, the terminal apparatus 30 determines the data format of print data based on descriptions in the acquired file (Process 5).

Then, the terminal apparatus 30 registers the print data in the determined data format in the folder 41 (Process 6).

The image forming apparatus 20 that has executed Process 15 periodically accesses the folder 41 and waits for registration of the print data.

When the registration of the print data is detected, the image forming apparatus 20 downloads the print data from the folder 41 (Process 16). Then, the image forming apparatus 20 executes printing based on the downloaded print data.

When the printing is finished, the image forming apparatus 20 deletes the folder 41 from the cloud storage 40 (Process 17). The deletion is complete deletion.

As shown in the processing sequence, the cloud storage 40 is used only for data exchange. In this exemplary embodiment, the image forming apparatus 20 makes a response via the cloud storage 40 about the processable data formats among the data formats providable by the terminal apparatus 30. Thus, a data format conversion service is unnecessary.

### Second Exemplary Embodiment

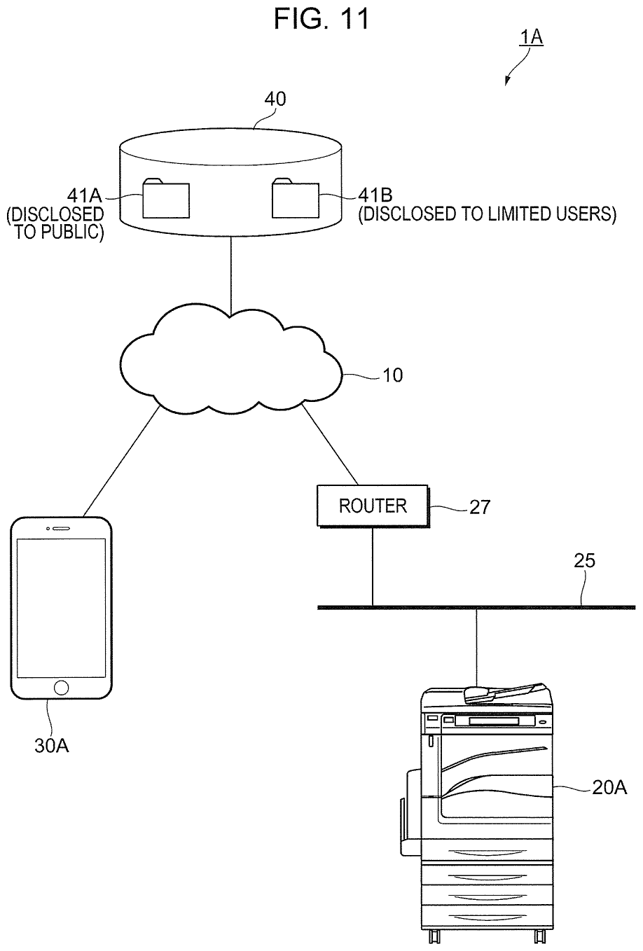

FIG. 11 illustrates a conceptual configuration of an information processing system 1A for use in a second exemplary embodiment. In FIG. 11, parts corresponding to those in FIG. 1 are represented by corresponding reference symbols.

In this exemplary embodiment, description is made of the information processing system 1A in which the confidentiality of print data is improved compared with the first exemplary embodiment.

The basic configuration of the information processing system 1A illustrated in FIG. 11 is identical to that in FIG. 1. The configuration differs in that two folders 41A and 41B generated on the cloud storage 40 are used for information exchange.

The folder 41A is generated by a user of a terminal apparatus 30A. The folder 41B is generated by an image forming apparatus 20A that has read a QR code from the terminal apparatus 30A. The folder 41A is set so as not to limit users having accessibility (that is, disclosed to public). The folder 41B is set so as to limit users having accessibility to the user of the terminal apparatus 30A and a user who installed the image forming apparatus 20A (that is, disclosed to limited users).

In this exemplary embodiment, expressions “image forming apparatus 20A” and “terminal apparatus 30A” are used to show that applications for data exchange that uses the two folders 41A and 41B are executed. The folder 41A is an example of a first storage area. The folder 41B is an example of a second storage area.

### <Configuration of Image Forming Apparatus>

The hardware configuration of the image forming apparatus 20A for use in this exemplary embodiment is identical to that of the image forming apparatus 20 (see FIG. 2) described in the first exemplary embodiment.

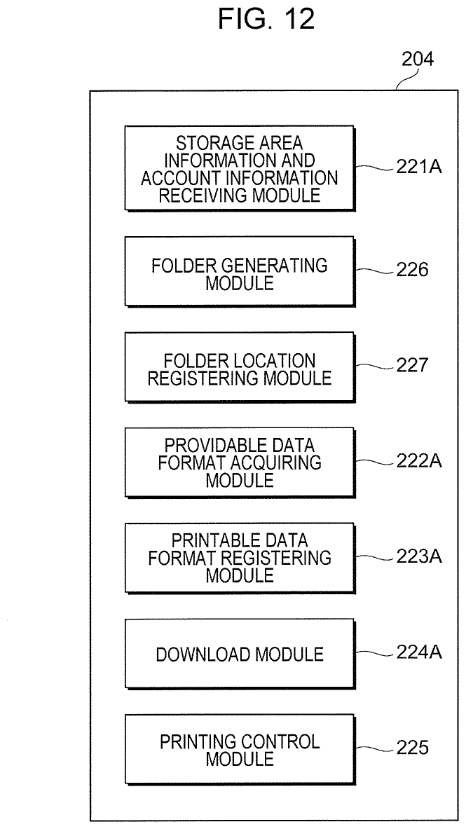

FIG. 12 illustrates the functional configuration of the control unit 204 of the image forming apparatus 20A (see FIG. 11) for use in the second exemplary embodiment. In FIG. 12, parts corresponding to those in FIG. 3 are represented by corresponding reference symbols.

Functional modules illustrated in FIG. 12 are implemented through execution of a program by the CPU 211 (see FIG. 2). The functional modules illustrated in FIG. 12 are examples of the functional modules provided by the control unit 204.

The control unit 204 of this exemplary embodiment functions as a storage area information and account information receiving module 221A that receives information on the folder 41A (see FIG. 11) provided from the user and account information of the user who operates the terminal apparatus 30A, a folder generating module 226 that generates the folder 41B to be disclosed to limited users, a folder location registering module 227 that registers locational information of the folder 41B in the folder 41A, a providable data format acquiring module 222A that acquires, from the folder 41B, information on data formats providable by the terminal apparatus 30A, a printable data format registering module 223A that registers, in the folder 41B, data formats printable by the image forming apparatus 20A, a download module 224A that downloads print data from the folder 41B, and the printing control module 225 that controls printing (image formation) that uses the downloaded print data.

The storage area information and account information receiving module 221A receives, from a QR code read by the image reading unit 201 (see FIG. 2), a URL indicating the location of the folder 41A on the Internet, which is specified by the user and disclosed to public, and account information for identifying the user who operates the terminal apparatus 30A. Examples of the account information include an account name and a mail address.

The folder generating module 226 generates, on the cloud storage 40, the folder 41B that is only accessible to the terminal apparatus 30A and the image forming apparatus 20A. The folder generating module 226 is a functional module unique to this exemplary embodiment.

The folder location registering module 227 registers a URL indicating the location of the folder 41B on the Internet, which is generated by the image forming apparatus 20A, in the folder 41A received via the QR code. The folder location registering module 227 is also a functional module unique to this exemplary embodiment. The folder location registering module 227 is an example of a first writer.

The providable data format acquiring module 222A differs from the providable data format acquiring module 222 (see FIG. 3) of the first exemplary embodiment in that a text file that describes data formats providable by the terminal apparatus 30A is acquired from the folder 41B disclosed to limited users.

The printable data format registering module 223A differs from the printable data format registering module 223 (see FIG. 3) of the first exemplary embodiment in that a text file that describes data formats processable by the image forming apparatus 20A is registered in the folder 41B disclosed to limited users. The printable data format registering module 223A is an example of a second writer.

The download module 224A differs from the download module 224 (see FIG. 3) of the first exemplary embodiment in that print data is downloaded from the folder 41B disclosed to limited users.

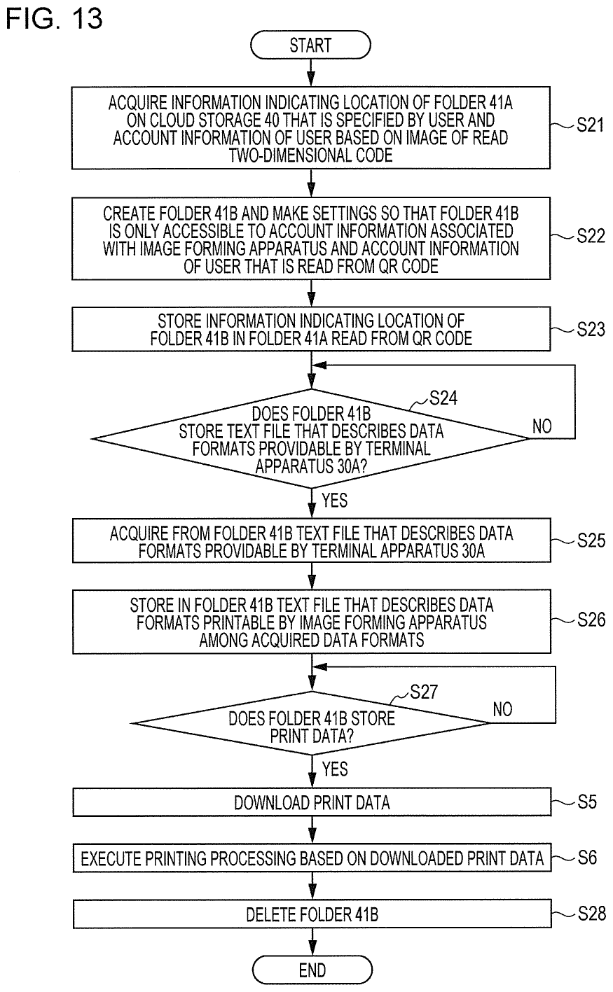

FIG. 13 is a flowchart for describing a processing operation to be executed by the image forming apparatus 20A for use in the second exemplary embodiment. In FIG. 13, parts corresponding to those in FIG. 6 are represented by corresponding reference symbols. The processing operation illustrated in FIG. 13 is implemented by cooperation between the modules described above. The symbol S in FIG. 13 represents a step.

The processing illustrated in FIG. 13 is also started when the image reading unit 201 (see FIG. 2) reads the display surface of the terminal apparatus 30A that displays an image of a QR code indicating the location of the folder 41A (see FIG. 11) generated on the cloud storage 40 (see FIG. 11) and account information indicating the user of the terminal apparatus 30A.

First, the image forming apparatus 20A acquires information indicating the location of the folder 41A on the cloud storage 40 that is specified by the user and the account information of the user based on the image of the read two-dimensional code (Step 21). As described above, anyone may access the folder 41A as well as the user who is operating the apparatus.

Next, the image forming apparatus 20A generates the folder 41B on the cloud storage 40 and makes settings so that the folder 41B is only accessible to account information associated with the image forming apparatus 20A and the account information of the user that is read from the QR code (Step 22).

Then, the image forming apparatus 20A stores information indicating the location of the folder 41B in the folder 41A read from the QR code (Step 23).

The image forming apparatus 20A determines whether the folder 41B stores a text file that describes data formats providable by the terminal apparatus 30A (Step 24).

When the result is “NO” in Step 24, the image forming apparatus 20A periodically accesses the folder 41B and determines whether format-request.txt is present.

When the result is “YES” in Step 24, the image forming apparatus 20A acquires, from the folder 41B, the text file that describes the data formats providable by the terminal apparatus 30A (Step 25).

Next, the image forming apparatus 20A stores, in the folder 41B, a text file that describes data formats printable by the image forming apparatus 20A among the acquired data formats (Step 26).

Then, the image forming apparatus 20A determines whether the folder 41B stores print data (Step 27).

When the result is “NO” in Step 27, the image forming apparatus 20A periodically accesses the folder 41B and determines whether print data is stored.

When the result is “YES” in Step 27, the image forming apparatus 20A downloads the print data from the folder 41B (Step 5).

Next, the image forming apparatus 20A executes printing processing based on the downloaded print data (Step 6).

When the printing is finished, the image forming apparatus 20A deletes the folder 41B (Step 28). When the folder 41B used for data exchange is deleted, the print data and format-response.txt are also deleted together. Thus, the confidentiality of the print data is maintained. The folder 41A may also be deleted together with the folder 41B.

### <Configuration of Terminal Apparatus>

The hardware configuration of the terminal apparatus 30A for use in this exemplary embodiment is identical to that of the terminal apparatus 30 (see FIG. 7) described in the first exemplary embodiment.

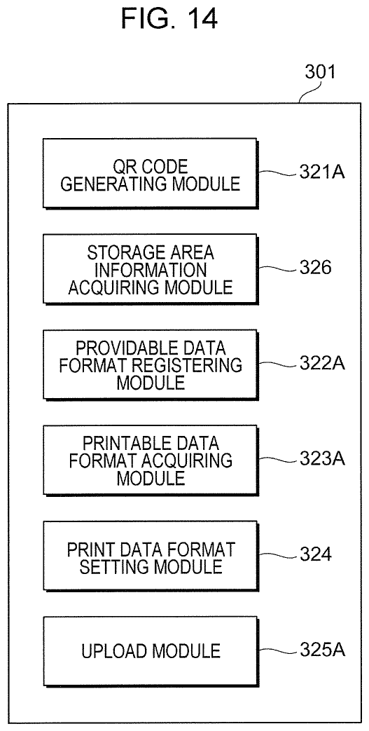

FIG. 14 illustrates the functional configuration of the control unit 301 of the terminal apparatus 30A (see FIG. 11) for use in the second exemplary embodiment. In FIG. 14, parts corresponding to those in FIG. 8 are represented by corresponding reference symbols.

Functional modules illustrated in FIG. 14 are implemented through execution of a program by the CPU 311 (see FIG. 7). The functional modules illustrated in FIG. 14 are examples of the functional modules provided by the control unit 301.

The control unit 301 of this exemplary embodiment functions as a QR code generating module 321A that converts, into a two-dimensional code, a URL indicating the location of the folder 41A generated on the Internet by the user and account information of the user, a storage area information acquiring module 326 that acquires a URL indicating the location of the folder 41B that is registered in the folder 41A by the image forming apparatus 20A, a providable data format registering module 322A that registers, in the acquired folder 41B, data formats providable by the terminal apparatus 30A, a printable data format acquiring module 323A that acquires printable data formats stored in the folder 41B, the print data format setting module 324 that sets one of the acquired data formats as the format of print data, and an upload module 325A that uploads the generated print data to the folder 41B.

The QR code generating module 321A differs from the QR code generating module 321 of the first exemplary embodiment in that account information of the user is added to information converted into a QR code.

The storage area information acquiring module 326 periodically accesses the folder 41A and monitors writing of a URL indicating the location of the folder 41B by the image forming apparatus 20A. When the writing of the URL indicating the location of the folder 41B is detected, the storage area information acquiring module 326 acquires the written URL.

The providable data format registering module 322A detects data formats of document data and image data that are convertible from the data format of a file specified as a printing target in the terminal apparatus 30A and registers a text file that describes the detected data formats (format-request.txt) in the folder 41B identified by the URL described above. There is a difference from the first exemplary embodiment in that the text file is registered in the folder 41B reported from the image forming apparatus 20A. The providable data format registering module 322A is an example of the writer.

The printable data format acquiring module 323A periodically accesses the folder 41B that stores the text file that describes the providable data formats and monitors storage of a response from the image forming apparatus 20A. Specifically, the printable data format acquiring module 323A waits for registration of format-response.txt in the folder 41B described above. When the registration is detected, the printable data format acquiring module 323A acquires printable data formats from format-response.txt. There is a difference from the first exemplary embodiment in that the folder 41B reported from the image forming apparatus 20A is monitored.

There is a difference from the first exemplary embodiment in that the upload module 325A uploads print data to the folder 41B. The upload module 325A is also an example of the uploader.

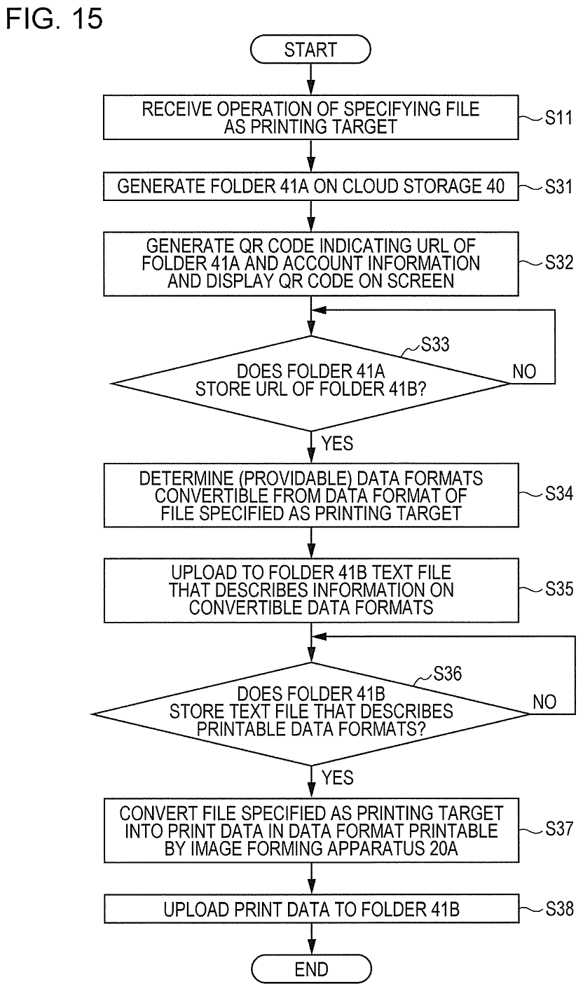

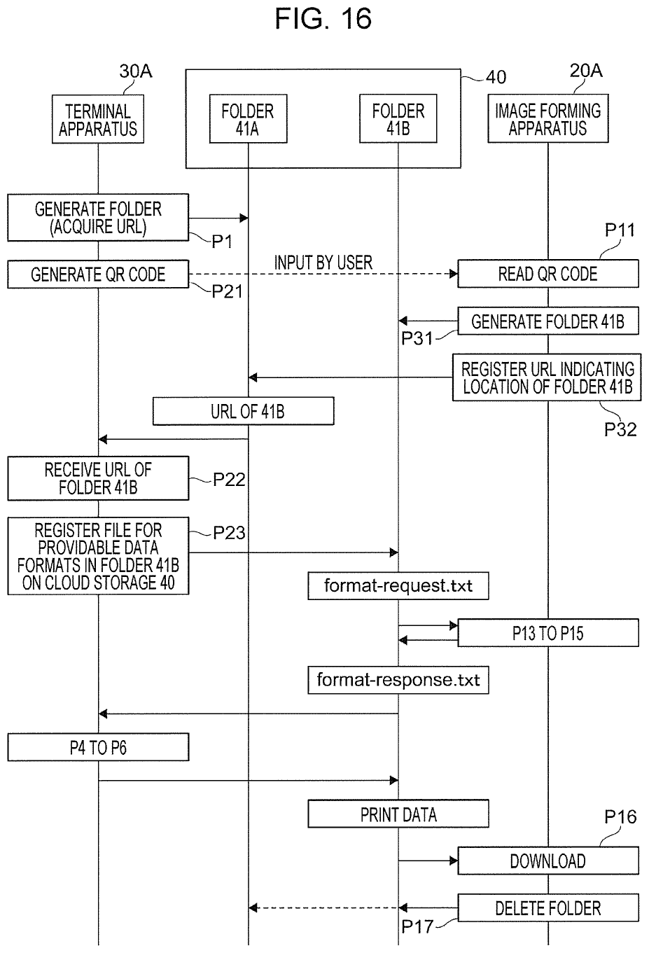

FIG. 15 is a flowchart for describing a processing operation to be executed by the terminal apparatus 30A for use in the second exemplary embodiment. In FIG. 15, parts corresponding to those in FIG. 9 are represented by corresponding reference symbols. The processing operation illustrated in FIG. 15 is implemented by cooperation between the modules described above. The symbol S in FIG. 15 represents a step.

First, the terminal apparatus 30A receives an operation of specifying a file as a printing target (Step 11). The operation of specifying the file is received via an operation screen of the terminal apparatus 30A.

Next, the terminal apparatus 30A generates the folder 41A on the cloud storage 40 in response to a user's operation (Step 31). The folder 41A is disclosed to public and anyone may access the folder 41A.

Then, the terminal apparatus 30A generates a QR code indicating a URL of the folder 41A and account information and displays the QR code on the screen (Step 32).

Next, the terminal apparatus 30A determines whether the folder 41A stores a URL of the folder 41B (Step 33). Anyone may acquire information indicating the location of the folder 41B but fails to access the folder 41B unless the person knows the account information of the user who operates the terminal apparatus 30A. That is, the folder 41B is kept in a state in which the confidentiality is high.

When the result is “NO” in Step 33, the terminal apparatus 30A periodically accesses the folder 41A and monitors registration of the URL indicating the location of the folder 41B.

When the result is “YES” in Step 33, the terminal apparatus 30A determines (providable) data formats convertible from the data format of the file specified as the printing target (Step 34).

Next, the terminal apparatus 30A uploads, to the generated folder 41B, a text file that describes information on the convertible data formats (Step 35). Specifically, the terminal apparatus 30A uploads format-request.txt.

Then, the terminal apparatus 30A determines whether the folder 41B stores a text file that describes printable data formats (Step 36). The folder 41B is only disclosed to the image forming apparatus 20A and the terminal apparatus 30A. Specifically, the terminal apparatus 30A determines whether format-response.txt is stored.

Next, the terminal apparatus 30A converts the file specified as the printing target into print data in a data format printable by the image forming apparatus 20A (Step 37). The file specified as the printing target is the file specified in Step 11. When a plurality of data formats are described in the text file whose storage has been confirmed in Step 36, one data format is determined in accordance with a predetermined rule.

The print data is a data file having a specified data format. If the data format of the specified file is the printable data format, the terminal apparatus 30A does not convert the data again.

Then, the terminal apparatus 30A uploads the print data to the folder 41B (Step 38).

### <Example of Processing Sequence>

FIG. 16 illustrates an example of a processing sequence to be executed in the information processing system 1A of the second exemplary embodiment. In FIG. 16, parts corresponding to those in FIG. 10 are represented by corresponding reference symbols. The symbol P in FIG. 16 represents a process.

The processing sequence is started when a user who desires printing at an outside place or the like operates the terminal apparatus 30A to generate the folder 41A on the cloud storage 40 (Process 1).

When the folder 41A is generated, the terminal apparatus 30A generates a QR code indicating a URL of the folder 41A and account information of the user who operates the terminal apparatus 30A (Process 21). There is a difference from the first exemplary embodiment in that the QR code includes the account information of the user.

In this exemplary embodiment, the image forming apparatus 20A reads the QR code displayed on the screen of the terminal apparatus 30A in this phase (Process 11). The URL of the folder 41A and the account information of the user who operates the terminal apparatus 30A are acquired from the QR code.

When the QR code is read, the image forming apparatus 20A generates, on the cloud storage 40, the folder 41B that is only accessible to the image forming apparatus 20A and the terminal apparatus 30A (Process 31). Then, the image forming apparatus 20A registers a URL indicating the location of the folder 41B in the folder 41A read from the QR code (Process 32).

At this time, the processing proceeds to the operation of the terminal apparatus 30A again. After the QR code has been generated, the terminal apparatus 30A monitors writing of a URL in the folder 41A. The terminal apparatus 30A receives the URL of the folder 41B written in the folder 41A (Process 22).

Then, the terminal apparatus 30A registers a file for data formats providable by the terminal apparatus 30A in the folder 41B on the cloud storage 40 (Process 23). That is, format-request.txt is registered.

After the URL indicating the location of the folder 41B has been registered in the folder 41A, the image forming apparatus 20A monitors the folder 41B. When the file registration in Process 23 is detected, the image forming apparatus 20A executes Processes 13 to 15 of the first exemplary embodiment. Specifically, the image forming apparatus 20A selects data formats processable by the image forming apparatus 20A from among the acquired data formats and registers, in the folder 41B, a text file that describes the selected data formats. That is, format-response.txt is registered in the folder 41B.

The registration of format-response.txt in the folder 41B is detected by the terminal apparatus 30A. After the detection, the terminal apparatus 30A executes Processes 4 to 6 of the first exemplary embodiment. Specifically, the terminal apparatus 30A generates print data in the data format reported from the image forming apparatus 20A and registers the print data in the folder 41B.

When the registration of the print data in the folder 41B is detected, the image forming apparatus 20A downloads the print data from the folder 41B (Process 16). Then, the image forming apparatus 20A executes printing based on the downloaded print data.

When the printing is finished, the image forming apparatus 20A deletes the folder 41B from the cloud storage 40 (Process 17).

In this exemplary embodiment, the access to the folder 41B to be used substantially for data exchange is limited to the image forming apparatus 20A and the terminal apparatus 30A. Therefore, the print data is not disclosed to arbitrary users even temporarily. The folder 41B is created every time a new printing request is made and is completely deleted after the printing has been finished. Even if another user executes printing by using the image forming apparatus 20A, the confidentiality of contents printed by a previous user is maintained.

### Other Exemplary Embodiments

In the exemplary embodiments described above, the image forming apparatus 20 includes the image reading unit 201. An external QR code reader may be connected to the image forming apparatus 20.

In the exemplary embodiments described above, the terminal apparatus 30 (see FIG. 1) or 30A (see FIG. 11) presents, by using the QR code, the URL indicating the location of the folder 41 (see FIG. 1) or 41A (see FIG. 11) generated on the cloud storage 40. The URL may be presented by using a barcode, which is one type of one-dimensional code. When the barcode is used, it is appropriate that the terminal apparatus 30 or the like be provided with a barcode generating module and the image forming apparatus 20 or the like be provided with a barcode reader or a barcode reading module.

The URL indicating the location of the folder 41 (see FIG. 1) or 41A (see FIG. 11) may directly be input manually by the user to the image forming apparatus 20 (see FIG. 1) or 20A (see FIG. 11). In this case, the QR code generating module 321 (see FIG. 8) and the storage area information receiving module 221 (see FIG. 3) that supports the QR code are unnecessary.

The URL indicating the location of the folder 41 (see FIG. 1) or 41A (see FIG. 11) may be reported from the terminal apparatus 30 or 30A to the image forming apparatus 20 or 20A by using near field communication (NFC), which is one type of close proximity wireless communication technology. For example, in NFC conforming to ISO/IEC 14443, direct communication may be performed by bringing antennas of apparatuses closer to each other within a range of about 10 cm. The portion where the antenna is provided is an example of a specific portion of an apparatus body. Although the communication performed by using NFC is communication based on a wireless connection system, the communication is direct communication that does not require login and is not therefore wireless network communication.

Also in the case of using the reporting by NFC, the QR code generating module 321 (see FIG. 8) and the storage area information receiving module 221 (see FIG. 3) that supports the QR code are unnecessary.

The exemplary embodiments described above are directed to the case in which the information exchange via the cloud storage 40 automatically proceeds based on the program executed by the terminal apparatus 30 or the like and the program executed by the image forming apparatus 20 or the like. The individual steps may be executed after waiting for user's operations in response to instructions from the programs.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

1. An image forming apparatus, comprising:
an acquirer that accesses a storage area on an Internet, which is specified by a user and has no limit for access authority, and acquires first data formats providable by an information processing apparatus as print data;
a writer that writes, in the storage area, a second data format processable by the image forming apparatus among the acquired first data formats; and
a downloader that downloads print data in the second data format when the print data in the second data format is stored in the storage area.

2. An image forming apparatus, comprising:
a first writer that accesses a first storage area on an Internet, which is specified by a user and has no limit for access authority, and writes information indicating a location of a second storage area on the Internet, access authority of which is limited to an information processing apparatus and the image forming apparatus;
an acquirer that accesses the second storage area and acquires first data formats providable by the information processing apparatus as print data;
a second writer that writes, in the second storage area, a second data format processable by the image forming apparatus among the first data formats acquired from the second storage area; and
a downloader that downloads print data in the second data format when the print data in the second data format is stored in the second storage area.

3. The image forming apparatus according to claim 1, wherein information indicating a location of the storage area on the Internet is acquired from the information processing apparatus by reading an image showing the information indicating the location of the storage area on the Internet.

4. The image forming apparatus according to claim 2, wherein information indicating a location of the first storage area on the Internet is acquired from the information processing apparatus by reading an image showing the information indicating the location of the first storage area on the Internet.

5. The image forming apparatus according to claim 3, wherein the image is displayed on a display part of the information processing apparatus.

6. The image forming apparatus according to claim 4, wherein the image is displayed on a display part of the information processing apparatus.

7. The image forming apparatus according to claim 1, wherein information indicating a location of the storage area on the Internet is acquired from the information processing apparatus by using a wireless connection system in which communication is established by bringing the information processing apparatus closer to a specific portion of an apparatus body.

8. The image forming apparatus according to claim 2, wherein information indicating a location of the first storage area on the Internet is acquired from the information processing apparatus by using a wireless connection system in which communication is established by bringing the information processing apparatus closer to a specific portion of an apparatus body.

9. The image forming apparatus according to claim 1, wherein the storage area is a cloud storage.

10. The image forming apparatus according to claim 2, wherein each of the first storage area and the second storage area is a cloud storage.

11. The image forming apparatus according to claim 1, wherein the first data formats and the second data format are described in text formats.

12. The image forming apparatus according to claim 2, wherein the first data formats and the second data format are described in text formats.

13. An information processing apparatus, comprising:
a writer that writes first data formats providable by the information processing apparatus as print data in a storage area on an Internet, which has no limit for access authority; and
an uploader that uploads, when a second data format processable by an image forming apparatus for use is written in the storage area, print data in the second data format to the storage area.

14. An information processing apparatus, comprising:
an acquirer that accesses a first storage area on an Internet, which has no limit for access authority, and acquires information indicating a location of a second storage area on the Internet, access authority of which is limited to an image forming apparatus for use and the information processing apparatus;
a writer that writes, in the second storage area, first data formats providable by the information processing apparatus as print data; and
an uploader that uploads, when a second data format processable by the image forming apparatus is written in the second storage area, print data in the second data format to the second storage area.

15. The information processing apparatus according to claim 13, wherein an image showing information indicating a location of the storage area on the Internet is generated and displayed on a display part.

16. The information processing apparatus according to claim 14, wherein an image showing information indicating a location of the first storage area on the Internet is generated and displayed on a display part.

17. The information processing apparatus according to claim 13, wherein information indicating a location of the storage area on the Internet is reported to the image forming apparatus by using a wireless connection system in which communication is established by bringing the information processing apparatus closer to a specific portion of an apparatus body.

18. The information processing apparatus according to claim 14, wherein information indicating a location of the first storage area on the Internet is reported to the image forming apparatus by using a wireless connection system in which communication is established by bringing the information processing apparatus closer to a specific portion of an apparatus body.
